(19) United States
(12) Patent Application Publication
(10) Pub. No.: US 2013/0300214 A1
(43) Pub. Date: Nov. 14, 2013

(54) TRANSMISSION CABLE, ELECTRONIC DEVICE USING THE SAME, AND METHOD FOR SWITCHING OPERATION MODE OF THE ELECTRONIC DEVICE

(71) Applicants: LITE-ON ELECTRONICS (GUANGZHOU) LIMITED, Guangzhou (CN); LITE-ON TECHNOLOGY CORPORATION, Taipei City (TW)

(72) Inventors: CHIA-WEN HSU, Taipei City (TW); CHIEN-CHUN MA, Hsinchu City (TW); LIN-YEAN LIN, Taichung City (TW)

(73) Assignees: LITE-ON TECHNOLOGY CORPORATION, TAIPEI CITY (TW); LITE-ON ELECTRONICS (GUANGZHOU) LIMITED, GUANGZHOU (CN)

(21) Appl. No.: 13/631,819

(22) Filed: Sep. 28, 2012

(30) Foreign Application Priority Data
May 11, 2012 (CN) 201210144091.7

(51) Int. Cl. H01H 47/00; H01R 3/00; H01B 7/00

(52) U.S. Cl. 307/125; 174/71 R; 439/489

(57) ABSTRACT

An exemplary embodiment of the present disclosure illustrates a transmission cable including a first port, a second port, a third port and a plurality of conduction wires. Through each respective one of the plurality of conduction wires, a power pin of the third port is connected to power pins of the first port and the second port, a ground pin of the third port is connected to a ground pin of the first port, and a specific pin of the third port is connected to a metal shielding case or the ground pin of the second port. The second port is floating when the specific pin of the third port is connected to the metal shielding case. Therefore, the stability of a transmission system established through the transmission cable can be guaranteed.

### BACKGROUND

1. Technical Field

The present invention relates to a transmission cable, in particular, to a transmission cable capable of achieving power management, an electronic device using the same, and a method for switching an operation mode of the electronic device.

2. Description of Related Art

Recently, newly developed electronic devices of various kinds are continuously launched. To compatibly perform data transmission between each of the electronic devices and a host apparatus, and to make the host apparatus provide sufficient power to the electronic device, different data transmission technologies and standards are specified according the requirements of different data transmission rates. Among them, universal serial bus (USB) technology is the most frequently used in daily life and is widely applied in several electronic devices, such as a person computer, a mobile phone, a hard disk, a digital camera, a projector, and a printer.

The electric currents required by the electronic devices of various kinds are different to each other. Some electronic devices (such as mobile phones) merely require lower electric currents to drive themselves, but other electronic devices (such as projectors) require higher electric currents to drive themselves or to achieve better performances (such as higher projecting brightness or higher image resolution). Thus, when a data transmission cable connects the host apparatus to the electronic device with higher power consumption (i.e. the electronic device which requires a higher electric current to drive itself), a Y cable is needed. Two ports of the Y cable are respectively adapted to be plugged into two reception ports of the host apparatus, and the other one port of the Y cable is adapted to be plugged into the reception port of the electronic device. Thus, the host apparatus can provide the electronic device through the Y cable with sufficient power from its two reception ports so as to drive the electronic device.

A conventional Y cable has a first port, a second port, and a third port. The first and second ports are respectively the master transmission port and the slave transmission port which are respectively adapted to connect the two reception ports of the host apparatus. The third port is adapted to connect the reception port of the electronic device. However, when the user unplugs the second port plugged in the host apparatus, the host apparatus would not provide sufficient power to the electronic device and the electronic device cannot detect such situation of only the first port left to transmit power to the electronic device, thereby causing the unexpected failure or decreasing the performance of the electronic device. Or, the other possible condition is that the electronic device might draw more electric current from the host apparatus through the first port to maintain the higher performance mode, thereby causing shutdown of the host apparatus since the electric current from the host apparatus is over drawn or instability of either the host apparatus or the electronic device.

Moreover, when the user unplugs the first port plugged in the host apparatus, the host apparatus would not provide the data and sufficient power to the electronic device. However, since the electronic device cannot detect the first port is unplugged from the host apparatus, and the host apparatus still provides the power to the electronic device through the second port, thereby causing the electronic device not to operate and waste of the power.

### SUMMARY

An exemplary embodiment of the present disclosure provides a transmission cable capable of achieving power management, and another exemplary embodiment of the present disclosure provides an electronic device capable of detecting a connection status of the transmission cable. When the electronic device is connected to the host apparatus through the transmission cable, without manually changing the operation mode of the electronic device, the electronic device can automatically adjust the operation mode and performance thereof according to the connection status of the transmission cable, such that stability of the electronic device is enhanced.

An exemplary embodiment of the present disclosure provides a transmission cable including a first port, a second port, a third port and a plurality of conduction wires. Each of the first through the third ports comprises a power pin and a ground pin, and the third port further comprises a specific pin. Through each respective one of the plurality of conduction wires, the power pin of the third port is connected to the power pins of the first port and the second port, the ground pin of the third port is connected to the ground pin of the first port, and the specific pin of the third port is connected to a metal shielding case or the ground pin of the second port. The ground pin of the second port is floating when the specific pin of the third port is connected to the metal shielding case.

An exemplary embodiment of the present disclosure provides an electronic device, wherein the electronic device is adapted to electrically connect a host apparatus through the transmission cable mentioned above, the host apparatus has a first and second receiving ports which respectively allow the first and second ports to plug in, and the electronic device comprises a third receiving port and a connection status detection circuit. The third receiving port allows the third port to plug in. The connection status detection circuit detects a status of the specific pin of the third port so as to control or instruct the electronic device to operate in a corresponding mode.

An exemplary embodiment of the present disclosure provides a method for switching an operation mode of an electronic device, wherein the electronic device is adapted to electrically connect a host apparatus through the transmission cable mentioned above, and the host apparatus has a first and a second receiving ports which respectively allow the first and second ports to plug in. Steps of the method are illustrated as follows. When the ground pin of the first port is not floating, a status of the specific pin of the third port is detected to control the electronic device to operate in a corresponding mode. When the ground pin of the first port is floating, the power of the electronic device is turned off to make the electronic device in power off state.

To sum up, the stability of a transmission system established through the transmission cable can be guaranteed. In addition, through using the transmission cable mentioned above, the damage of the host apparatus or the electronic device due to the insufficient supply power can be prevented.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1A is a circuit diagram of a transmission cable according to an exemplary embodiment of the present disclosure.

FIG. 1B is a circuit diagram of a transmission cable according to another one exemplary embodiment of the present disclosure.

FIG. 2A is a schematic diagram of a transmission system showing that the transmission cable according to the exemplary embodiment of the present disclosure is successfully plugged in an electronic device and a host apparatus.

FIG. 2B is a schematic diagram of the transmission system showing that the transmission cable according to the exemplary embodiment of the present disclosure is not successfully plugged in the electronic device and the host apparatus.

FIG. 2C is a schematic diagram of the transmission system showing that the transmission cable according to the exemplary embodiment of the present disclosure is also not successfully plugged in the electronic device and the host apparatus.

FIG. 3A is a block diagram of the connection status detection circuit in the transmission system according to one exemplary embodiment of the present disclosure.

FIG. 3B is a block diagram of the connection status detection circuit in the transmission system according to another exemplary embodiment of the present disclosure.

FIG. 4A is a flow chart of a method for switching an operation mode of the electronic device according to one exemplary embodiment of the present disclosure.

FIG. 4B is a flow chart of a method for switching an operation mode of the electronic device according to another exemplary embodiment of the present disclosure.

FIG. 4C is a flow chart of a method for switching an operation mode of the electronic device according to still another exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or similar parts.

Exemplary embodiments of the present disclosure provide a transmission cable capable of achieving power management, a corresponding electronic device, and a transmission system. The electronic device can detect a connection status between the host apparatus and the transmission cable by the transmission cable and can correspondingly adjust its performance and operation mode (such as the best mode with higher power consumption and a normal mode with lower power consumption) according to the detected connection status, such that the power consumption required is reduced and the damage of the host apparatus or the electronic device due to the insufficient supply power is prevented.

[Exemplary Embodiment of Transmission Cable]

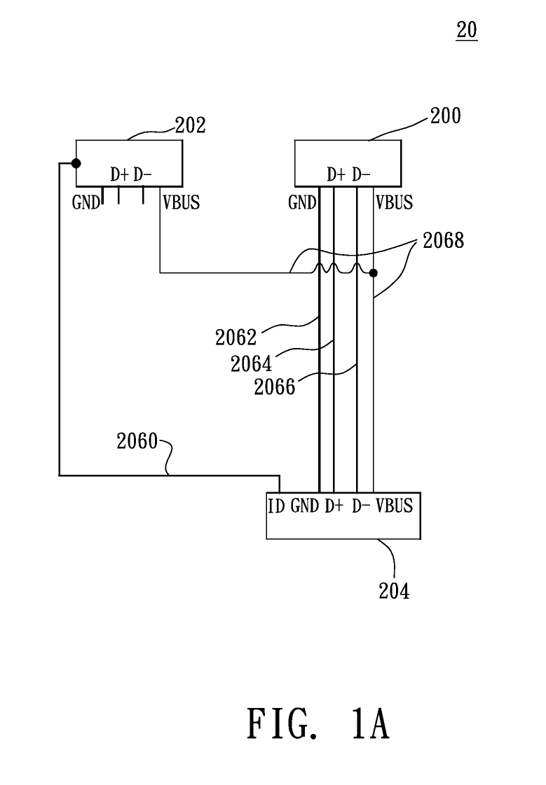

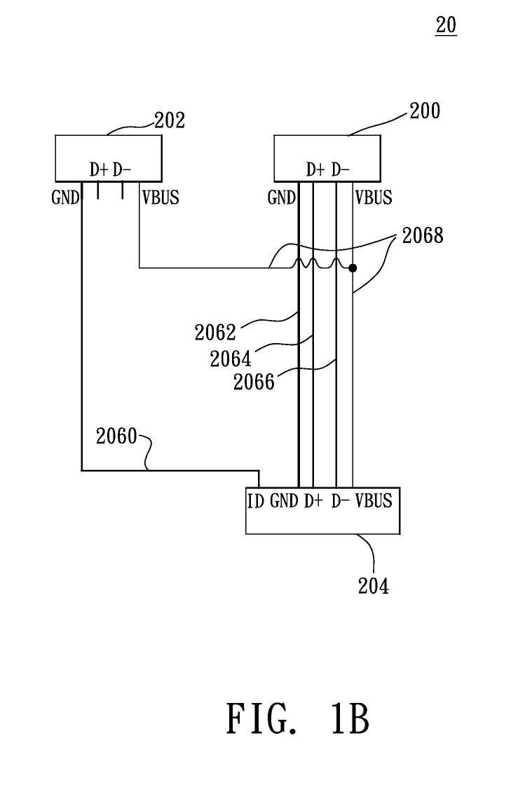

FIG. 1A is a circuit diagram of a transmission cable according to an exemplary embodiment of the present disclosure. In FIG. 1A, a transmission cable 20 may be, for example, a USB Y cable, and comprises a first port 200, a second port 202, a third port 204, and a plurality of conduction wires 2060 through 2068. In FIG. 1A, a power pin VBUS of the third port 204 is connected to power pins VBUS of both the first port 200 and the second port 202 through the conduction wire 2068, a ground pin GND of the third port 204 is connected to a ground pin GND of the first port 200 through conduction wire 2062, an identification pin ID of the third port 204 is connected to a metal shielding case of the second port 202 through the conduction wire 2060, and data pins D+ and D− of the third port 204 are respectively connected to data pins D+ and D− of the first port 200 respectively through the conduction wires 2064 and 2066. A ground pin GND and data pins D+, D− of the second port 202 are floating. It is noted that the number of the data pins in another exemplary embodiment may be larger than two, and the present disclosure is not limited thereto.

It is noted that, though the transmission cable 20 is for example the USB Y cable, the present disclosure is not limited thereto. In addition, the identification pin ID of the third port 204 may not be connected to the metal shielding case of the second port 202, but connected to the ground pin GND of the second port 202 through the conduction wire 2060 (referring to the transmission cable in another one exemplary embodiment of FIG. 1B). Moreover, in this exemplary embodiment, the conduction wires 2064 and 2066 may be removed; that is, the data pins D+ and D− of the third port 204 are not respectively connected to the data pins D+ and D− of the first port 200, and thus the transmission cable 20 merely transmits the power.

[Exemplary Embodiment of Transmission System]

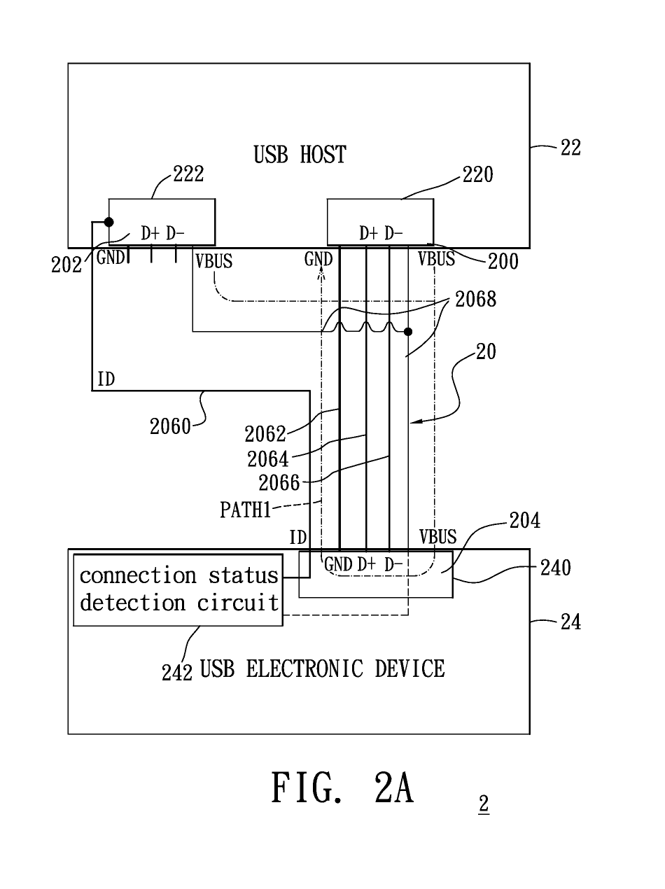

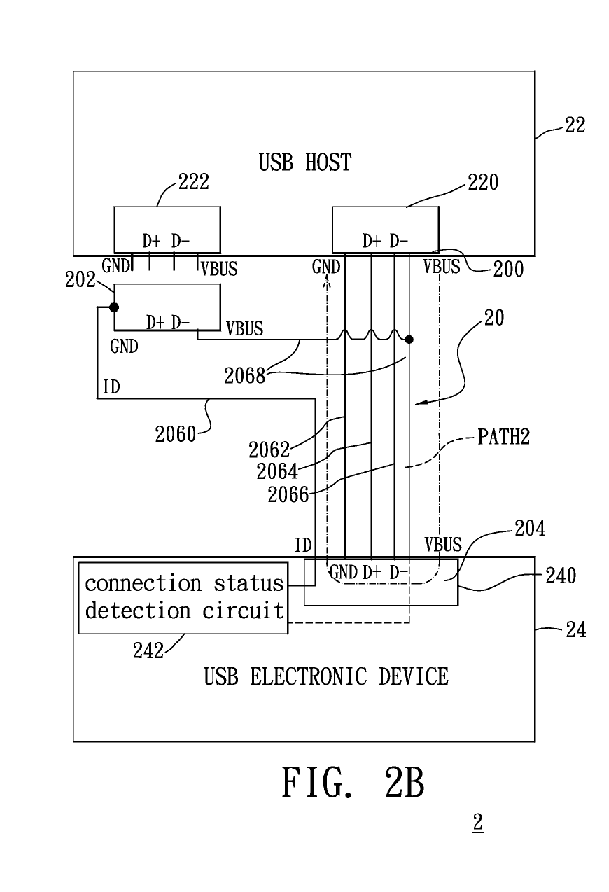

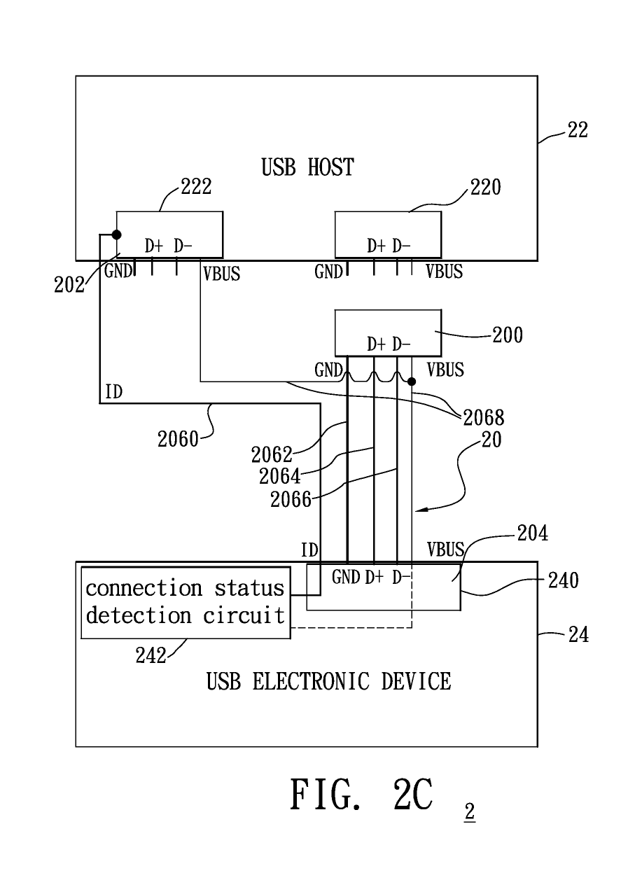

FIG. 2A is a schematic diagram of a transmission system showing that the transmission cable according to the exemplary embodiment of the present disclosure is successfully plugged in an electronic device and a host apparatus. In FIG. 2A, the transmission system 2 comprises the transmission cable (such as Y cable 20), the host apparatus (such as USB host apparatus 22), and the electronic device (such as USB electronic device 24), and the USB host apparatus 22 is electrically connected to the USB electronic device 24 through the transmission cable 20. It is noted that, though the transmission system 2 in the exemplary embodiments of FIGS. 2A, 2B, 2C adopts the USB interface, the present disclosure is not limited thereto. The details of each of components in the transmission system 2 are illustrated as follows.

The first port 200 and the second port 202 of the transmission cable 20 are respectively plugged in the first receiving port 220 and the second receiving port 222 of the USB host apparatus 22, and the third port 204 is plugged in the third receiving port 240 of the USB electronic device 24. The USB host apparatus 22 provides sufficient power to drive the USB electronic device 24 and the data required by the USB electronic device 24 through the data pins D+ and D− of the first receiving port 220 (a master receiving port). The first port 200 is also called the master transmission port, and the second port 202 is also called the slave transmission port. The first receiving port 220 and the second receiving port 222 are correspondingly called the master receiving port and the slave receiving port respectively.

In addition, the USB electronic device 24 further comprises a connection status detection circuit 242, and the connection status detection circuit 242 detects the status of the identification pin ID of the third port 204 to control or instruct the USB electronic device 24 to operate in a corresponding mode.

To put it concretely, whether the second port is plugged in the second receiving port 222 of the USB host apparatus 22 is determined by the status of the identification pin ID of the third port 204 detected by the connection status detection circuit 242. Thus, the connection status detection circuit 242 can further control or instruct the USB electronic device 24 to operate in the corresponding mode according to the detection result which is used to represent whether the second port 202 is plugged in the second receiving port 222).

Furthermore, in one exemplary embodiment, the connection status detection circuit 242 is electrically connected to the identification pin ID, and in another exemplary embodiment, the connection status detection circuit 242 can be further electrically connected to the power pin VBUS of the third port 204 (as presented by the dash line in FIG. 2A).

In the USB standard, the identification pin ID is merely used to recognize the USB electronic device 24 as the A type or B type one. However, in the exemplary embodiment, the identification pin ID is connected to the metal shielding case or the ground pin GND of the second port 202. Thus, the USB electronic device 24 can detect the connection status of the second port 202 to correspondingly adjust the performance and operation mode of the USB electronic device 24.

In addition, being different from the conventional Y cable in which the ground pin GND of the third port is connected to the ground pins GND of the first port and the second port, the ground pin GND of the third port 204 of the transmission cable in the exemplary embodiment is merely connected to the ground pin GND of the first port 200 through the conduction wire 2062. Thus, when the first port 200 is unplugged from the first receiving port 220, the USB electronic device 24 cannot obtain the power from the USB host apparatus 22.

Thus, when the transmission cable 20 is successfully plugged in both of the USB host apparatus 22 and the USB electronic device 24; that is, the first port 200, the second port 202, and the third port 204 are successfully plugged in the first receiving port 220, the second receiving port 222, and the third receiving port 240 respectively, since the first port 200 has been successfully plugged in the first receiving port 220 and the ground pin GND of the first port 200 is not floating, the USB host apparatus 22 can provide the power to the USB electronic device 24 through the first receiving port 220 and the second receiving port 222, thereby forming a current path PATH1 from the respective power pins VBUS of the first receiving port 220 and the second receiving port 222 to the ground pin GND of first receiving port 220.

Then, the connection status detection circuit 242 detects the status of the identification pin ID of the third port 204 to know that the second port 202 has been successfully plugged in the second receiving port 222 of the USB host apparatus 22, and thus the USB host apparatus 22 can provide power to the USB electronic device 24 through both of the first receiving port 220 and the second receiving port 222. Meanwhile, the USB electronic device 24 is sufficiently provided with the power, thus being able to smoothly operate in a first mode with higher power consumption (defined as e.g. a best mode) and to perform data transmission through the data pins D+ and D−.

FIG. 2B is a schematic diagram of the transmission system showing that the transmission cable according to the exemplary embodiment of the present disclosure is not successfully plugged in the electronic device and the host apparatus. In the transmission system 2 of FIG. 2B, the second port 202 is not successfully plugged in the second receiving port 222 of the USB host apparatus 22 due to an accident, the user's fault connection, or the other reasons. At this time, the USB host apparatus 22 can provide the power to the USB electronic device 24 merely through the first receiving port 220, thereby forming a current path PATH2 from the power pin VBUS of the first receiving port 220 to the ground pin GND of the first receiving port 220. The connection status detection circuit 242 detects the status of the specific pin ID to know that the second port 202 is not successfully plugged in the second receiving port 222 of the USB host apparatus 22, thus the USB electronic device 24 can operate in a second mode with lower power consumption (defined as e.g. a normal mode) and perform data transmission through the data pins D+ and D−.

FIG. 2C is a schematic diagram of the transmission system showing that the transmission cable according to the exemplary embodiment of the present disclosure is also not successfully plugged in the electronic device and the host apparatus. In the transmission system 2 of FIG. 2C, the first port 200 is not successfully plugged in the second receiving port 222 of the USB host apparatus 22 due to an accident, the user's fault connection, or the other reasons. Since the ground pin GND of the first port 200 is floating, the USB host apparatus 22 cannot provide the power to the USB electronic device 24, and that is, no current path is formed. Meanwhile, the USB electronic device 24 is provided with no power, thus being powered off or unable to be turned on.

[Exemplary Embodiment of Connection Status Detection Circuit]

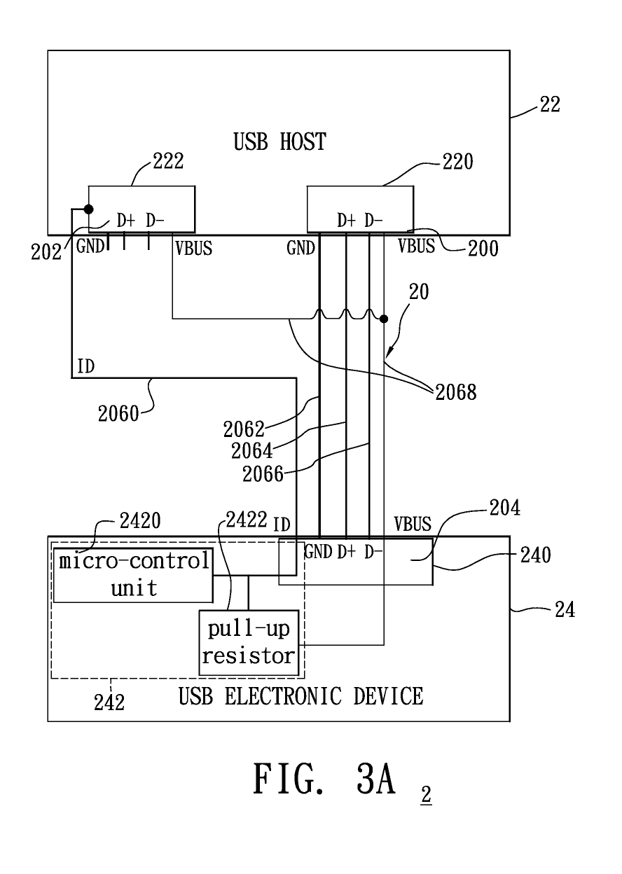

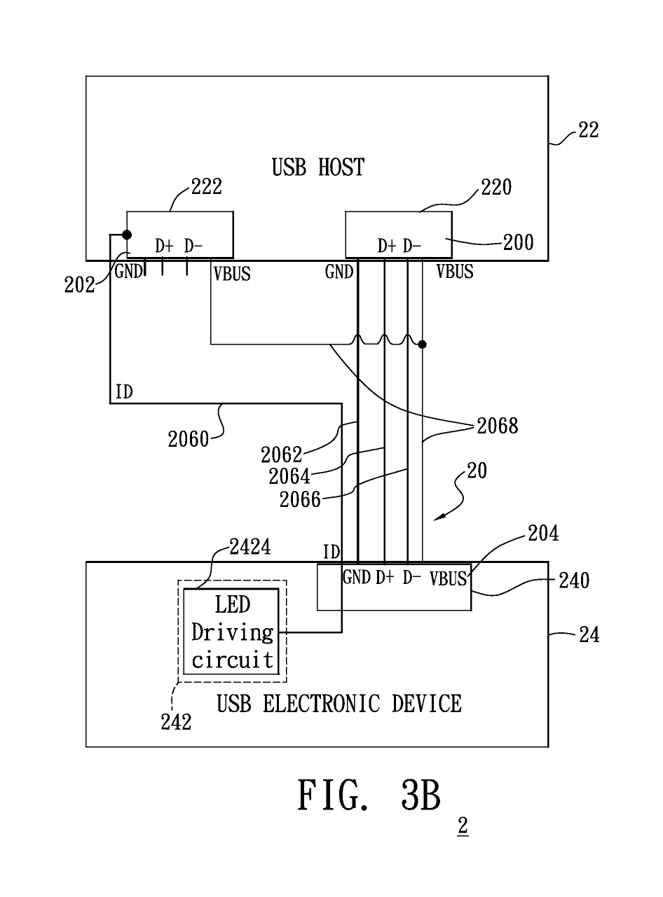

In practice, the connection status detection circuit 242 of the USB electronic device can be implemented by a micro-control unit and a pull-up resistor. FIG. 3A is a block diagram of the connection status detection circuit in the transmission system according to one exemplary embodiment of the present disclosure. In FIG. 3A, the connection status detection circuit 242 of the USB electronic device 24 comprises a micro-control unit 2420 coupled to the identification pin ID of the third receiving port 240 and a pull-up resistor 2422 coupled between the power pin VBUS and the identification pin ID of the third receiving port 240. The micro-control unit 2420 determines a connection status of the transmission cable 20 to correspondingly adjust the operation mode of the USB electronic device 24.

When the first port 200, the second port 202, and the third port 204 of the transmission cable 20 are successfully plugged in the corresponding receiving ports respectively, the metal shielding case coupled to the identification pin ID can be considered as the ground terminal, and the voltage level of the identification pin ID is approaching to zero, (i.e. the voltage level of the identification pin ID is at a logic low level), such that the micro-control unit 2420 can detect that the first port 200 and the second port 202 are successfully plugged in the corresponding receiving ports respectively, thereby to control or instruct the USB electronic device 24 to operate in the first mode.

When merely the first port 200 and the third port 204 are successfully plugged in the corresponding receiving ports respectively, but the second port 202 is not plugged in the corresponding receiving port, the voltage level of the identification pin ID can be pulled up to the voltage level of the power pin VBUS (i.e. the voltage level of the identification pin ID is at a logic high voltage level), such that the micro-control unit 2420 detects merely the second port 202 is not plugged in the second receiving port 222. Thus, the micro-control unit 2420 controls or instructs the USB electronic device 24 to operate in the second mode.

In addition, when merely the second port 202 and the third port 204 are successfully plugged in the corresponding receiving ports, the USB host apparatus 22 does not provide the power to the USB electronic device 24 since the ground pin GND of the first port 200 is floating, and that is, no current path is formed. Meanwhile, the USB electronic device 24 is provided with no power, thus being powered off and or unable to be turned on.

[Another Exemplary Embodiment of Connection Status Detection Circuit]

In addition, the connection status detection circuit 242 can be implemented by a light emission diode (LED) driving circuit. The USB electronic device 24 can be for example, a USB projector which has the LED driving circuit itself Thus, the cost of the USB electronic device 24 can be reduced by implementing the connection status detection circuit 242 with the LED driving circuit.

FIG. 3B is a block diagram of the connection status detection circuit in the transmission system according to another exemplary embodiment of the present disclosure. In FIG. 3B, the connection status detection circuit 242 of the USB electronic device 24 comprises a LED driving circuit 2424, whose enable pin is electrically connected to the identification pin ID. The LED driving circuit 2424 detects the voltage level (for example, the logic high or low level) of identification pin ID and whether the identification pin ID is floating. By detecting the identification pin ID with the LED driving circuit 2424, the connection status of the transmission cable can be determined, thereby to control or instruct the USB electronic device 24 to operate in the first or second mode.

To put it concretely, when the first port 200, the second port 202, and the third port 204 of the transmission cable 20 are successfully plugged in the corresponding receiving ports, the metal shielding case connected to the identification pin ID can be considered as the ground terminal, and thus the LED driving circuit 2424 detects that the voltage level of the identification pin ID is approaching to zero. Thus, the connection status detection circuit 242 knows that the first port 200 and second port 202 are successfully plugged in the corresponding receiving ports, and correspondingly controls or instructs the USB electronic device 24 to operate in the first mode. While the USB electronic device 24 is exemplified as the USB projector, the LED driving circuit 2424 under this condition can directly control the LED of the USB electronic device 24 to increase the brightness or intensity thereof, such that the projecting image is brighter (i.e. the first mode is a higher luminance projecting mode).

On the other hand, when merely the first port 200 and third port 204 are successfully plugged in the corresponding receiving ports, the LED driving circuit 2424 detects that the identification pin ID is floating. Thus, the connection status detection circuit 242 knows that the first port 200 is successfully plugged in the corresponding receiving port, but the second port 202 is not successfully plugged in the corresponding receiving port, such that the connection status detection circuit 242 controls or instructs the USB electronic device 24 to operate in the second mode. In the similar manner, taking that the USB electronic device 24 is the USB projector as an example, the LED driving circuit 2424 under this condition can directly control the LED of the USB electronic device 24 to decrease the brightness or intensity thereof, such that the luminance of the projecting image is darker (i.e. the second mode is a lower luminance projecting mode).

In addition, when merely the second port 202 and the third port 204 are successfully plugged in the corresponding receiving ports, the USB host apparatus cannot provides the power to the USB electronic device 24 since the ground pin GND of the first port 200 is floating, and the USB electronic device 24 will thus be powered off and or unable to be turned on.

It is noted that the implementation of the connection status detection circuit 242 in the present disclosure is not limited to the above-mentioned exemplary embodiments. The connection status detection circuit 242 may be implemented by the other technical means for detecting the status of the identification pin ID to know whether the second port 202 is successfully plugged in the second receiving port 222 of the USB host apparatus 22, thereby controlling or instructing the USB electronic device 24 to operate in the corresponding mode.

[Exemplary Embodiment of Specification of Transmission Cable]

It is noted that, the first, second, and third ports of the transmission cable in the exemplary embodiments associated with FIG. 1 through FIG. 3B are specified by USB specification. For example, the first port 200 and the second port 202 are standard USB ports, and the third port 204 is a mini or micro USB port. However, the specification of the transmission cable can be modified by the person skilled in the art according to the transmission specification used by the electronic device and the host apparatus.

In one implementation, the first port and the second port can be the IEEE 1394 ports with six or nine pins, and the third port can be the IEEE 1394 port with nine pins or the port with 30 pins associated with an Apple Computer product such as an iPad, iPod, MacBook, or iPhone. In the other implementation, the first port and the second port can be standard USB ports, and the third port can be the port with 30 pins associated with any product of Apple Computer.

For example, if the three ports of the transmission cable are IEEE 1394 ports with nine pins, a specific pin (such as the undefined 7th pin) of IEEE 1394 can be used to replace the identification pin ID mentioned above, and the specific pin is also connected to the metal shielding case of the second port. In another example, if the third port of the transmission cable is the port with 30 pins associated with any product of Apple Computer, a specific pin (such one of the undefined 7th, 14th, and 17th pins) in the 30 pins can be used to replace the identification pin ID mentioned above.

It is noted that, the person skilled in the art can adopt the specification of the first through the third ports of the transmission cable according to the transmission specification used by the host apparatus and the electronic device. The present disclosure is not limited to the specification of the first through the third ports.

In addition, though the transmission cables in the above exemplary embodiments are exemplified as a Y cable, the transmission cable of the present disclosure is not limited thereto. In other exemplary embodiments, the transmission cable can have more than three ports. In addition, the electronic device can be any kinds of electronic devices, such as a projector, a hand phone, a fan, an audio device, a display card, a keyboard and a mobile hard disk, and the host apparatus can any kinds of host apparatus, such as a personal computer, an industrial computer, a notebook, a pad, a smart phone and the other computing device with computing ability.

[Exemplary Embodiment of Method for Switching Operation Mode of Electronic Device]

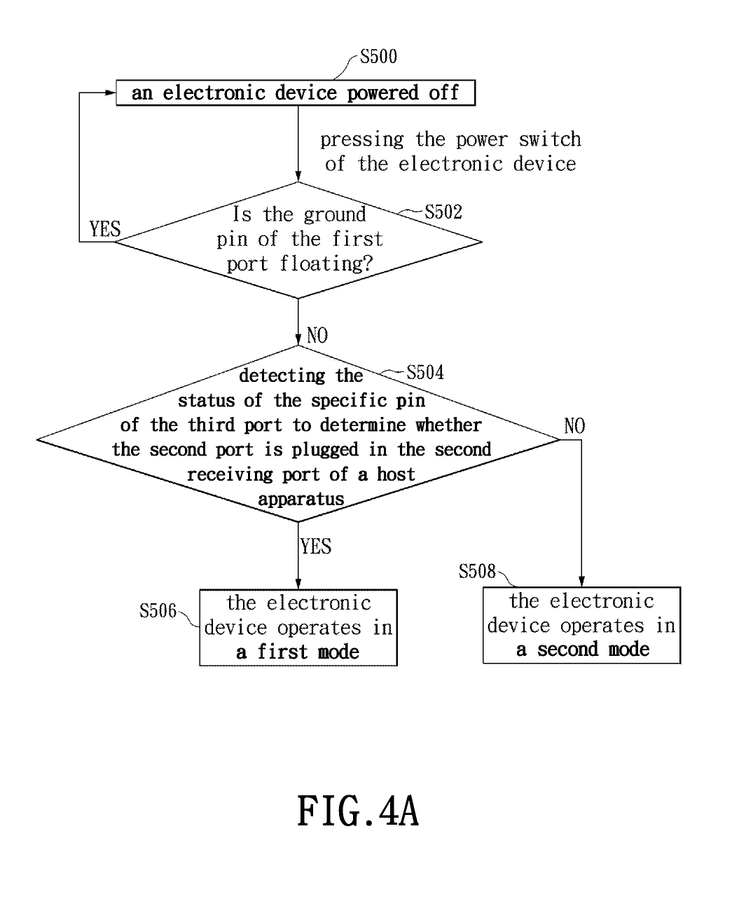

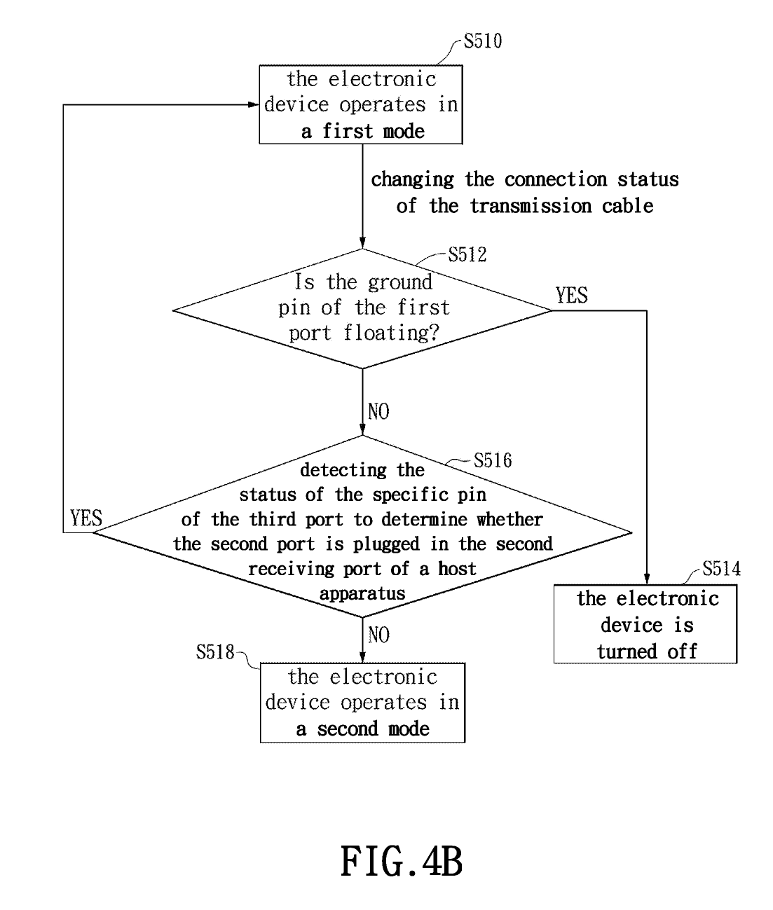

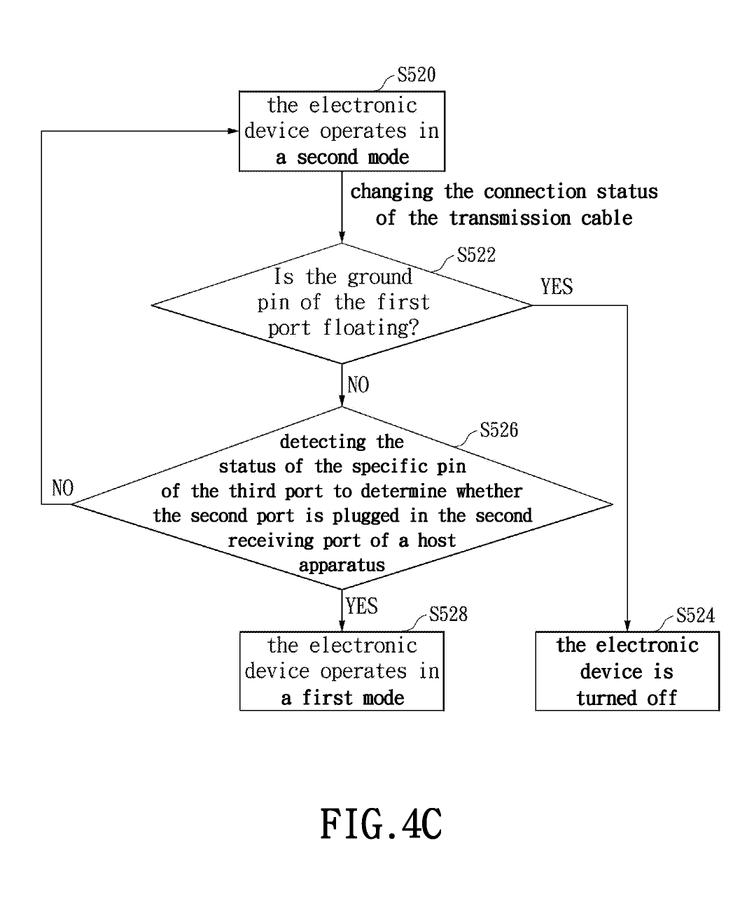

FIG. 4A is a flow chart of a method for switching an operation mode of the electronic device according to one exemplary embodiment of the present disclosure. Referring also to FIG. 2A through FIG. 2C, at step S500 of the exemplary embodiment in FIG. 4A, the USB electronic device 24 is powered off since for instance, the USB electronic device 24 is not turned on or has no supply power. Next, the user presses the power switch of the of the USB electronic device 24 to turn on the power, and at step S502, if the ground pin GND of the first port 200 is not floating (i.e. the first port 200 is plugged in the first receiving port 220), the USB electronic device 24 can be turned on to enter the power on state; if the ground pin GND of the first port 200 is floating (i.e. the condition as shown in FIG. 2C that the first port 200 is not plugged in the first receiving port 220), the method for switching the operation mode thus goes back to execute step 500, and then the USB electronic device 24 is still powered off.

At step S504, after the USB electronic device 24 is turned on, the connection status detection circuit 242 detects the status of a specific pin (such as the identification pin ID) of the third port 204 to determine whether the second port 202 is plugged in the second receiving port 222. If that the second port 202 is not plugged in the second receiving port 222 (i.e. the condition as shown in FIG. 2B) is determined, at step S508, the USB electronic device 24 is controlled or instructed to operate in the second mode (e.g. a normal mode with lower power consumption). If that the second port 202 is plugged in the second receiving port 222 (i.e. the condition as shown in FIG. 2A) is determined, at step S506, the USB electronic device 24 is controlled or instructed to operate in the first mode (e.g. a best mode with higher power consumption).

Referring to FIG. 2A through FIG. 2C and FIG. 4B, in which FIG. 4B is a flow chart of a method for switching an operation mode of the electronic device according to another exemplary embodiment of the present disclosure. At step S510 of the exemplary embodiment in FIG. 4B, the USB electronic device 24 operates in the first mode (i.e. the condition shown as in FIG. 2A). Next, when the connection status of the transmission cable 20 is changed, and at step S512, if the ground pin GND of the first port 200 is floating (i.e. the condition shown as in FIG. 2C that the first port is unplugged in the first receiving port 220 due to an accident or the user's fault connection), at step S514, the power of the USB electronic device 24 is turned off, thus being powered off. If the ground pin GND of the first port 200 is not floating, at step S516, the connection status detection circuit 242 detects the status of the specific pin (such as the identification pin ID) of the third port 204 to determine whether the second port 202 is plugged in the second receiving port 222. If that the second port 202 is not plugged in the second receiving port 222 (i.e. the condition as shown in FIG. 2B) is determined, at step S518, the USB electronic device 24 is controlled or instructed to operate in the second mode (e.g. the normal mode with lower power consumption). If that the second port 202 is plugged in the second receiving port 222 (i.e. the condition as shown in FIG. 2A) is determined, the method for switching the operation mode goes back to execute step S510, and then the USB electronic device 24 is controlled or instructed to operate in the first mode (e.g. the best mode with higher power consumption).

Referring to FIG. 2A through FIG. 2C and FIG. 4C, in which FIG. 4C is a flow chart of a method for switching an operation mode of the electronic device according to still another exemplary embodiment of the present disclosure. At step S520 of the exemplary embodiment in FIG. 4C, the USB electronic device 24 operates in the second mode (i.e. the condition shown as in FIG. 2B). Next, when the connection status of the transmission cable 20 is changed, and at step S522, if the ground pin GND of the first port 200 is floating (i.e. the condition shown as in FIG. 2C that the first port is not plugged in the first receiving port 220 due to an accident or the user's fault connection), at step S524, the power of the USB electronic device 24 is turned off, thus being powered off. If the ground pin GND of the first port 200 is not floating, at step S526, the connection status detection circuit 242 detects the status of the specific pin (such as the identification pin ID) of the third port 204 to determine whether the second port 202 is plugged in the second receiving port 222. If that the second port 202 is not plugged in the second receiving port 222 (i.e. the condition as shown in FIG. 2B) is determined, the method for switching the operation mode goes back to execute step S520, and then the USB electronic device 24 is controlled or instructed to operate in the second mode (e.g. the normal mode with lower power consumption). If that the second port 202 is plugged in the second receiving port 222 (i.e. the condition as shown in FIG. 2A) is determined, at step S528, and then the USB electronic device 24 is controlled or instructed to operate in the first mode (e.g. the best mode with higher power consumption).

[Possible Results of Exemplary Embodiments]

To sum up, exemplary embodiments of the present disclosure provides a transmission cable capable of achieving power management, a corresponding electronic device, a transmission system using the same, and a method for switching an operation mode of an electronic device. By using the transmission cable of the present disclosure, when the firs and second ports of the transmission cable are connected to the host apparatus, the electronic device operates in the first mode. When merely the first port of the transmission cable is connected to the host apparatus, the electronic device operates in the second mode. When the first port of the transmission cable is not connected to the host apparatus, the electronic device is powered off. In addition, the electronic device can determine whether the second port of the transmission cable is plugged in the second receiving port of the host apparatus by detecting the status of the specific pin. Thus, the operation mode and system performance of the electronic device can be adjusted and controlled according to the detected connection status of the specific pin, such that the stability of the transmission system is increased. Thus, the stability of the transmission system constructed through the transmission cable can be guaranteed. In addition, through the transmission cable mentioned above, the damage of the host apparatus or the electronic device due to the insufficient power can be prevented.

The above-mentioned descriptions represent merely the exemplary embodiment of the present disclosure, without any intention to limit the scope of the present disclosure thereto. Various equivalent changes, alternations or modifications based on the claims of present disclosure are all consequently viewed as being embraced by the scope of the present disclosure.

What is claimed is:

1. A transmission cable, comprising:
a first port;
a second port;
a third port, wherein each of the first through the third ports comprises a power pin and a ground pin, and the third port further comprises a specific pin; and
a plurality of conduction wires, wherein through each respective one of the plurality of conduction wires, the power pin of the third port is connected to the power pins of the first port and the second port, the ground pin of the third port is connected to the ground pin of the first port, and the specific pin of the third port is connected to a metal shielding case or the ground pin of the second port;
wherein the ground pin of the second port is floating when the specific pin of the third port is connected to the metal shielding case.

2. The transmission cable according to claim 1, wherein a plurality of data pins of the second port are floating, and a plurality of data pins of the third port are connected to a plurality of data pins of the first port through respective twos of the plurality of conduction wires.

3. The transmission cable according to claim 1, wherein the transmission cable is a universal serial bus transmission cable and the specific pin of the third port is an identification pin.

4. The transmission cable according to claim 1, wherein the transmission cable is an IEEE 1394 transmission cable with nine pins, and the specific pin of the third port is an undefined pin of IEEE 1394.

5. The transmission cable according to claim 1, wherein the transmission cable is a transmission cable with 30 pins associated with an iPad, an iPod, a MacBook, or an iPhone of Apple Computer, wherein the specific pin of the third port is one of undefined pins of Apple Computer.

6. An electronic device adapted to electrically connect to a host apparatus through an transmission cable, comprising:
a third receiving port, for allowing a third port of the transmission cable to plug in; and
a connection status detection circuit, for detecting a status of a specific pin of the third port of the transmission cable so as to control or instruct the electronic device to operate in a corresponding mode;
wherein the transmission cable comprises a first, a second, and the third ports and a plurality of conduction wires, each of the first through the third ports comprises a power pin and a ground pin, and the third port further comprises the specific pin; through each respective one of the plurality of conduction wires, the power pin of the third port is connected to the power pins of the first port and the second port, the ground pin of the third port is connected to the ground pin of the first port, and the specific pin of the third port is connected to a metal shielding case or the ground pin of the second port, wherein the ground pin of the second port is floating when the specific pin of the third port is connected to the metal shielding case; the host apparatus comprises a first and second receiving ports which respectively allow the first and second ports to plug in.

7. The electronic device according to claim 6, wherein the transmission cable is a universal serial bus transmission cable, the specific pin of the third port is an identification pin, and the electronic device is a universal serial bus electronic device.

8. The electronic device according to claim 6, wherein the connection status detection circuit detects the specific pin of the third port to determine whether the second port is successfully plugged in the second receiving port, thereby controlling the electronic device to operate in the corresponding mode accordingly; when the ground pin of the first port is not floating and that the second port is plugged in the second receiving port is determined, the electronic device operates in a first mode; when the ground pin of the first port is not floating and that the second port is not plugged in the second receiving port is determined, the electronic device operates in a second mode; and
when the ground pin of the first port is floating, the electronic device is in power off state.

9. The electronic device according to claim 8, wherein the first mode is a best mode with higher power consumption, and the second mode is a normal mode with lower power consumption.

10. The electronic device according to claim 6, wherein the connection status detection circuit is a light emission diode driving circuit having an enable pin electrically connected to the specific pin, and the connection status detection circuit is configured to detect a voltage level of the specific pin and whether the specific pin is floating; when that the voltage level of the specific pin is at a logic low level is detected, the electronic device operates in a first mode; and when that the specific pin is floating is detected, the electronic device operates in a second mode.

11. The electronic device according to claim 6, wherein the connection status detection circuit comprises:
a pull-up resistor, having a first end connected to the power pin of the third port through the third receiving port;
a micro-control unit, electrically connected to a second end of the pull-up resistor, and connected to the specific pin of the third port through the third receiving port;
wherein when the micro-control unit detects that a voltage level of the specific pin is at a logic high level, the electronic device operates in a second mode; and when the micro-control unit detects that the specific pin is at a logic low level, the electronic device operates in a first mode.

12. A method for switching an operation mode of an electronic device, the electronic device being adapted to electrically connect a host apparatus through an transmission cable, comprising:
when a ground pin of a first port of the transmission cable is not floating, detecting a status of a specific pin of a third port of the transmission cable to control the electronic device to operate in a corresponding mode; and
when the ground pin of the first port is floating, turning off the power of the electronic device to make the electronic device in power off state;
wherein the transmission cable comprises the first, a second, and the third ports and a plurality of conduction wires, each of the first through the third ports comprises a power pin and a ground pin, and the third port further comprises the specific pin; through each respective one of the plurality of conduction wires, the power pin of the third port is connected to the power pins of the first port and the second port, the ground pin of the third port is connected to the ground pin of the first port, and the specific pin of the third port is connected to a metal shielding case or the ground pin of the second port, wherein the ground pin of the second port is floating when the specific pin of the third port is connected to the metal shielding case; the host apparatus comprises a first and second receiving ports which respectively allow the first and second ports to plug in.

13. The method according to claim 12, wherein that the specific pin of the third port is detected to determine whether the second port is successfully plugged in the second receiving port, thereby controlling the electronic device to operate in the corresponding mode; when the ground pin of the first port is not floating and that the second port is plugged in the second receiving port is determined, the electronic device is controlled to operate in a first mode; and when the ground pin of the first port is not floating and that the second port is not plugged in the second receiving port is determined, the electronic device is controlled to operate in a second mode, wherein the first mode is a best mode with higher power consumption, and the second mode is a normal mode with lower power consumption.
